(19) United States
(12) Patent Application Publication
(10) Pub. No.: US 2019/0367306 A1
(43) Pub. Date: Dec. 5, 2019

(54) SENSOR ASSEMBLY AND IMAGE FORMING APPARATUS

(71) Applicant: CANON KABUSHIKI KAISHA, Tokyo (JP)

(72) Inventor: Ryosuke Nanai, Tokyo (JP)

(21) Appl. No.: 16/418,173

(22) Filed: May 21, 2019

(30) Foreign Application Priority Data
May 30, 2018 (JP) 2018-104003

(51) Int. Cl. B65H 7/02; G03G 15/00

(52) U.S. Cl. CPC B65H 7/02; G03G 2215/00616; G03G 15/6502

(57) ABSTRACT

Provided is a sensor control apparatus including a main board and a first sensor to a third sensor that are connected in series to the main board. The main board operates the first sensor to the third sensor based on a normal operation mode of operating all the first sensor to the third sensor and a power reduction mode of operating only the first sensor. In the first sensor to the third sensor, the first sensor that operates in the power reduction mode is arranged on an upstream side of the second sensor and the third sensor that do not operate in the power reduction mode, the upstream side being set to a side on which the main board is provided. With such a configuration, the sensor control apparatus can suppress power consumption by operating only a required sensor at a time of the power reduction mode.

### BACKGROUND OF THE INVENTION

### Field of the Invention

The present disclosure relates to a technology for controlling a sensor configured to detect a sheet when the sheet is being conveyed in, for example, a copying machine, a printer, or other such image forming apparatus.

### Description of the Related Art

In an image forming apparatus and an auto document feeder (ADF), a large number of sensors are arranged in order to control internal devices. For example, the image forming apparatus is mounted with a large number of sensors including a sensor to be used for detecting presence or absence of a sheet, a sensor to be used for detecting a conveying position of the sheet, and a sensor to be used for detecting opening or closing of an exterior cover of the apparatus. The image forming apparatus or other such apparatus controls the internal devices based on detection results of the sensors, to thereby perform, for example, sheet conveyance control. To that end, a large number of sensors arranged at various positions in the apparatus and a control board configured to acquire the detection results of the respective sensors and perform control are connected to one another through a cable. As the number of sensors increase, a number of cables to be used inside the image forming apparatus or other such apparatus also increases. As the number of cables increases, the wiring space and a number of connectors on the control board increase. The increases in number of cables and number of connectors hinder downsizing of the entire apparatus, which causes an increase in cost. Therefore, there is proposed a technology for reducing the number of cables and the number of connectors by connecting a plurality of sensors in series to the control board (see Japanese Patent Application Laid-Open No. 2008-59161).

When the plurality of sensors are connected in series, the detection results of the respective sensors are sequentially sent from a sensor on a downstream side far from the control board to a sensor on an upstream side close to the control board, to thereby be transmitted to the control board. With such a configuration, when transmitting the detection result of a given sensor on the downstream side to the control board, it is required to energize all the sensors connected on the upstream side of the given sensor. For that reason, even when only the detection result obtained from a given sensor arranged on the downstream side is to be acquired, power is consumed by the sensors on upstream of the given sensor. The present disclosure has an object to connect a plurality of sensors in an appropriate order even with a configuration in which the plurality of sensors are connected in series.

### SUMMARY OF THE INVENTION

A sensor assembly according to the present disclosure includes: a plurality of sensors electrically connected in series; and a controller configured to control each of the plurality of sensors in sequence, wherein the plurality of sensors includes a first sensor and a second sensor, wherein the second sensor is electrically connected to the controller through the first sensor, wherein the controller performs a first operation mode in which the first sensor and the second sensor are repeatedly operated, and a second operation mode in which the first sensor is repeatedly operated by skipping the second sensor.

Further features of the present invention will become apparent from the following description of exemplary embodiments (with reference to the attached drawings).

### BRIEF DESCRIPTION OF THE DRAWINGS

FIG. 1 is a configuration diagram of an image forming apparatus according to one embodiment of the present disclosure.

FIG. 2 is a configuration diagram of a main board and a sensor.

FIG. 3 is a flow chart for illustrating operation control processing for a sensor at a time of a normal operation mode.

FIG. 4 is a timing chart exhibited when operations of respective sensors are controlled at the time of the normal operation mode.

FIG. 5 is an explanatory diagram of power supply states at a time of a power reduction mode.

FIG. 6 is a flow chart for illustrating operation control processing for a sensor at the time of the power reduction mode.

FIG. 7 is a timing chart exhibited when operations of respective sensors are controlled at the time of the power reduction mode.

### DESCRIPTION OF THE EMBODIMENTS

Now, an embodiment of the present disclosure is described in detail with reference to the accompanying drawings.

### Configuration of Image Forming Apparatus

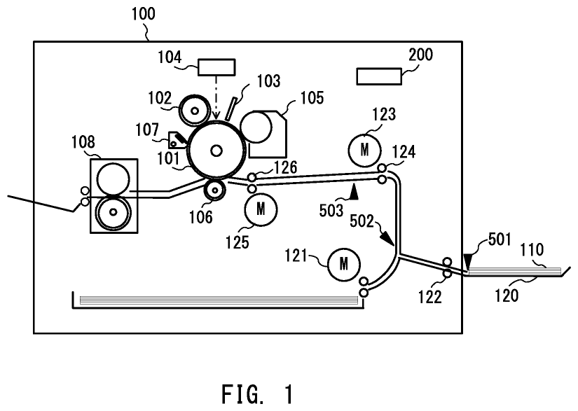

FIG. 1 is a configuration diagram of an image forming apparatus 100 including a sensor control apparatus according to this embodiment. The image forming apparatus 100 employs an electrophotographic method. The image forming apparatus 100 includes a photosensitive member 101 to be used for image formation, a charging device 102, a potential sensor 103, an exposure device 104, a developing device 105, a transfer unit 106, a cleaner 107, and a fixing device 108. The image forming apparatus 100 includes, as a configuration for feeding a sheet 110, a manual feed tray 120 on which the sheet 110 is to be placed, feed rollers 122, conveyance rollers 124, and conveyance rollers 126. A plurality of sensors 501, 502, and 503 are provided on a conveyance path along which the sheet 110 is to be fed. Along a conveyance direction of the sheet 110, the sensor 501 in a first stage, the sensor 502 in a second stage, and the sensor 503 in a third stage are arranged at predetermined intervals. The image forming apparatus 100 includes stepping motors 121, 123, and 125. The image forming apparatus 100 has its operation controlled by a controller 200.

The photosensitive member 101 is rotated clockwise in FIG. 1. The charging device 102 uniformly charges a surface of the photosensitive member 101 being rotated. The photosensitive member 101 having the surface uniformly charged is exposed by the exposure device 104 in accordance with an image signal, to thereby form thereon an electrostatic latent image corresponding to the image signal. The developing device 105 develops the electrostatic latent image to form a toner image on the surface of the photosensitive member 101. In order to measure a potential of the electrostatic latent image, the potential sensor 103 is provided between an exposure position to be used by the exposure device 104 and the development position to be used by the developing device 105. The toner image formed on the surface of the photosensitive member 101 is transferred onto the sheet 110 by the transfer unit 106. A transfer residual toner remaining on the photosensitive member 101 after the transfer is collected by the cleaner 107. The sheet 110 onto which the toner image has been transferred has the toner image fixed by the fixing device 108, and is delivered from the image forming apparatus 100. With the above-mentioned operation, a product on which an image is printed is obtained.

Now, a feeding operation of the sheet 110 is described. When starting the feeding operation, the controller 200 detects presence or absence of the sheet 110 on the manual feed tray 120 by the sensor 501. When the sheet 110 is present on the manual feed tray 120, the controller 200 starts to feed the sheet 110 placed on the manual feed tray 120 by the feed rollers 122. The controller 200 causes the stepping motor 121 to start to drive the feed rollers 122. The feed rollers 122 convey the sheets 110 one by one from the manual feed tray 120 to the conveyance rollers 124.

The sensor 502 is provided on a conveyance path between the feed rollers 122 and the conveyance rollers 124. The sensor 502 detects the presence or absence of the sheet 110 at a detection position defined on the conveyance path extending from the feed rollers 122 to the conveyance rollers 124. The controller 200 detects whether or not the sheet 110 has passed through the detection position within a predetermined period based on a detection result of the sensor 502.

The conveyance rollers 124 are rotated by the stepping motor 123. When the sensor 502 detects the sheet 110, the controller 200 causes the stepping motor 123 to start to drive the conveyance rollers 124. The conveyance rollers 124 are thus rotated, to thereby convey the sheet 110, which has been conveyed from the feed rollers 122, to the conveyance rollers 126.

The sensor 503 is provided on a conveyance path between the conveyance rollers 124 and the conveyance rollers 126. The sensor 503 detects the presence or absence of the sheet 110 at a detection position defined on the conveyance path extending from the conveyance rollers 124 to the conveyance rollers 126. The controller 200 detects whether or not the sheet 110 has passed through the detection position within a predetermined period based on a detection result of the sensor 503.

The conveyance rollers 126 are rotated by the stepping motor 125. When the sensor 503 detects the sheet 110, the controller 200 causes the stepping motor 125 to start to drive the conveyance rollers 126. The conveyance rollers 126 are thus rotated, to thereby convey the sheet 110, which has been conveyed from the conveyance rollers 124, to the transfer unit 106.

A timing at which the conveyance rollers 126 convey the sheet 110 to the transfer unit 106 is adjusted in accordance with a timing at which the toner image formed on the photosensitive member 101 is conveyed to the transfer unit 106. With this adjustment, the toner image is transferred onto the sheet 110 while the sheet 110 and the toner image formed on the photosensitive member 101 pass through the transfer unit 106 in an overlapping state. The controller 200 may also control the conveyance speed of the sheet 110 conveyed by the conveyance roller 126 so that the toner image on the photosensitive member 101 passes through the transfer unit 106 while overlapping with the sheet 110.

The sheet 110 is not only fed from the manual feed tray 120 but may also be fed from a sheet feeding cassette provided to the image forming apparatus 100. In this case, a sensor configured to detect the presence or absence of the sheet 110 received in the sheet feeding cassette is provided to the sheet feeding cassette. When the sensor detects that the sheet 110 is present in the sheet feeding cassette, the sheet 110 starts to be fed.

The sensors 501, 502, and 503 in this embodiment are each formed of, for example, a photo interrupter. In this case, the sensors 501, 502, and 503 each include a light emitting unit (for example, light emitting diode (LED)) and a light receiving unit (for example, phototransistor) configured to receive light emitted from the light emitting unit. The sensors 501, 502, and 503 can each detect the presence or absence of the sheet 110 when the sheet 110 pushes a shielding object provided at the detection position on the conveyance path to block an optical path formed between the LED and the phototransistor. However, the configuration of the sensors 501, 502, and 503 is not limited thereto as long as the configuration allows the sheet 110 being conveyed on the conveyance path to be detected at the detection position. For example, the sensors 501, 502, and 503 may each be formed of an LED and a phototransistor that are arranged so as to be opposed to each other across a conveyance path, and be configured to detect the sheet 110 by having an optical path blocked when the sheet 110 passes through the conveyance path. In another case, the sensors 501, 502, and 503 may each be configured to detect the sheet 110 by emitting light from an LED and forming an optical path to a phototransistor when the light is reflected by the sheet 110 on a conveyance path.

### Controller

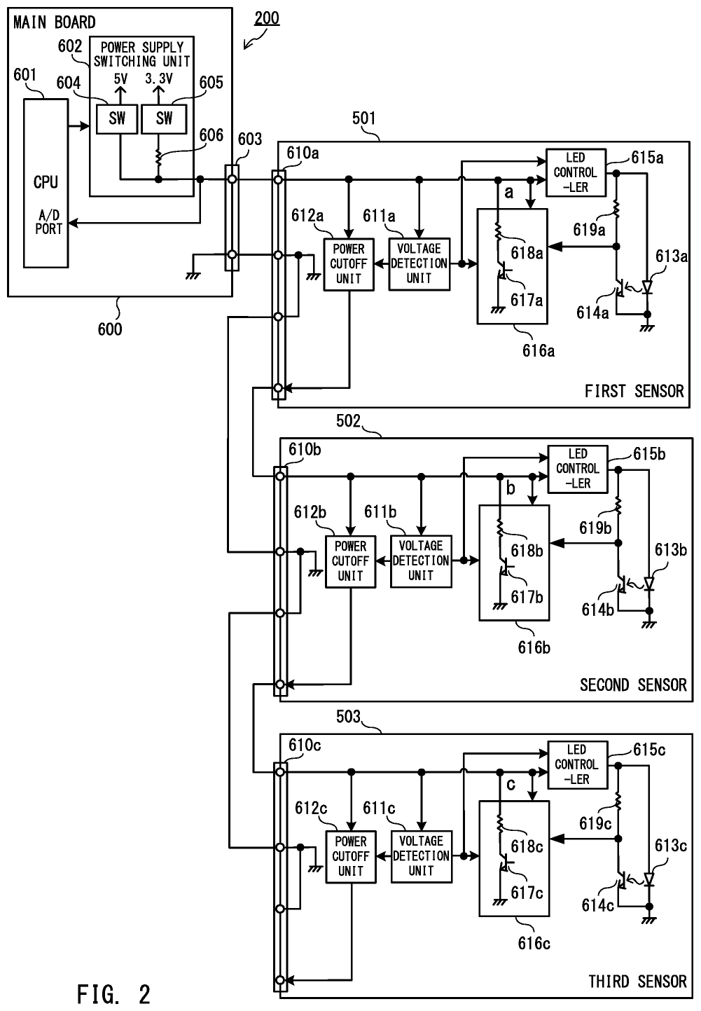

FIG. 2 is a configuration diagram of a main board included in the controller 200 and sensors. In the following description, the sensor 501 is referred to as “first sensor 501”. The sensor 502 is referred to as “second sensor 502”. The sensor 503 is referred to as “third sensor 503”. A main board 600 is a sensor control apparatus configured to control detection operations of the first sensor 501 to the third sensor 503 to acquire detection results of those sensors.

The first sensor 501 to the third sensor 503 are connected in series to the main board 600. Assuming that the main board 600 is on an upstream side, the first sensor 501 to the third sensor 503 are connected to the main board 600 in order of the first sensor 501, the second sensor 502, and the third sensor 503 from the upstream side. The first sensor 501 to the third sensor 503 have the same internal configuration. The main board 600 and the first sensor 501, the first sensor 501 and the second sensor 502, and the second sensor 502 and the third sensor 503 are respectively connected by different single power supply lines. A power supply voltage is applied from the main board 600 to the first sensor 501 to the third sensor 503 by the power supply lines. In addition, the respective detection results of the first sensor 501 to the third sensor 503 are input to the main board 600 by the power supply lines. The main board 600, the first sensor 501, the second sensor 502, and the third sensor 503 are connected to a common ground.

The main board 600 includes at least a central processing unit (CPU) 601 configured to control the operations of the first sensor 501 to the third sensor 503 and a power supply switching unit 602 configured to switch the power supply voltage to be applied to the first sensor 501 to the third sensor 503.

The power supply switching unit 602 switches the power supply voltage under control of the CPU 601. The power supply switching unit 602 applies the power supply voltage having three different kinds of voltage values to the first sensor 501 to the third sensor 503. In this embodiment, the power supply switching unit 602 switches the power supply voltage to be applied to the first sensor 501 to the third sensor 503 among three kinds of 0 V, 3.3 V, and 5 V. The power supply switching unit 602 applies the power supply voltage while sequentially switching the voltage value irrespective of, for example, a conveyance timing of the sheet 110. The power supply switching unit 602 includes two switches (SWs) 604 and 605. When the switch 604 is in a conductive state and the switch 605 is in a cutoff state, the power supply voltage is 5 V. When the switch 604 is in a cutoff state and the switch 605 is in a conductive state, the power supply voltage is 3.3 V. When both the switches 604 and 605 are in a cutoff state, the power supply voltage is 0 V.

The main board 600 includes, in the power supply switching unit 602, a pull-up resistor 606 for acquiring the detection results of the first sensor 501 to the third sensor 503. A predetermined voltage (in this case, 3.3 V) is applied to one end of the pull-up resistor 606 via the switch 605. The main board 600 includes a connector 603 for connection to the first sensor 501 through the power supply line.

The first sensor 501 includes a connector 610a, a voltage detection unit 611a, a power cutoff unit 612a, an LED 613a, a phototransistor 614a, an LED controller 615a, and a sensor latch unit 616a. The connector 610a is not only connected to the main board 600 through the power supply line, but also connected to the second sensor 502 provided on a downstream side through another power supply line.

The voltage detection unit 611a detects the power supply voltage applied from the main board 600, and outputs a control signal for performing conduction control of the power cutoff unit 612a and the LED controller 615a based on the voltage value. An operation of the voltage detection unit 611a is described later in detail.

The power cutoff unit 612a includes a switching element on a supply path for supplying the power supply voltage to the sensor (second sensor 502) in the subsequent stage. The power cutoff unit 612a switches a supply state of the power supply voltage applied from the main board 600 to the second sensor 502 in the subsequent stage when the switching element is switched based on the control signal acquired from the voltage detection unit 611a. That is, the power supply line for connecting the main board 600 and the first sensor 501 and the power supply line for connecting the first sensor 501 and the second sensor 502 are connectable via the power cutoff unit 612a. The switching element is, for example, a metal oxide semiconductor (MOS) field effect transistor (FET). When the voltage of the control signal from the voltage detection unit 611a becomes lower than the power supply voltage applied from the main board 600 by a gate threshold voltage (for example, 1 V), the FET is brought into a cutoff state. In this case, the power cutoff unit 612a inhibits the power supply voltage from being supplied to the second sensor 502 in the subsequent stage.

The LED 613a is a light emitting unit configured to emit light by a current flowing based on the power supply voltage applied from the main board 600. The phototransistor 614a is a light receiving unit configured to operate by receiving the light emitted from the LED 613a. The LED 613a and the phototransistor 614a form a detector configured to detect the presence or absence of the sheet 110.

In this embodiment, the phototransistor 614a is brought into a conductive state when receiving light. A collector terminal of the phototransistor 614a is connected to a path for applying the power supply voltage to the LED 613a via a resistor 619a. The collector terminal of the phototransistor 614a is also connected to the sensor latch unit 616a. When the phototransistor 614a is in the conductive state, a voltage value of a voltage by which the power supply voltage has dropped at the resistor 619a is input to the sensor latch unit 616a as the detection result of the first sensor 501. When the phototransistor 614a is in a cutoff state, the power supply voltage is input to the sensor latch unit 616a as the detection result of the first sensor 501. The phototransistor 614a itself is in a high impedance state when being in the cutoff state. The sensor latch unit 616a can latch the conductive state or the cutoff state (open state) of the phototransistor 614a. The phototransistor 614a is brought into the cutoff state when, for example, the light emitted from the LED 613a is blocked by the sheet 110.

The LED controller 615a includes a switching element on the path for applying the power supply voltage to the LED 613a. The LED controller 615a switches an application state of the power supply voltage applied from the main board 600 to the LED 613a by switching the switch element based on a control signal acquired from the voltage detection unit 611a. The switching element is, for example, a MOS FET. When the voltage of the control signal from the voltage detection unit 611a becomes lower than the power supply voltage applied from the main board 600 by the gate threshold voltage (for example, 1 V), the FET is brought into a conductive state, and the LED controller 615a applies the power supply voltage to the LED 613a. When the power supply voltage is applied to the LED 613a, a current flows therethrough, to thereby cause the LED 613a to emit light. In the other cases (including a time of power-on), the FET is brought into a cutoff state, which inhibits the LED control unit 615a from applying the power supply voltage to the LED 613a. A current does not flow when the power supply voltage is not applied, and hence the LED 613a does not emit light.

When the LED 613a emits light, the detector formed of the LED 613a and the phototransistor 614a operates. When the LED 613a does not emit light, the detector formed of the LED 613a and the phototransistor 614a stops operating.

The sensor latch unit 616a includes a transistor 617a functioning as a switching element and a resistor 618a. In the sensor latch unit 616a, the transistor 617a operates based on the state of the voltage detection unit 611a and the operation of the phototransistor 614a. A collector terminal of the transistor 617a is connected to the power supply line of the first sensor 501 at a contact “a” via the resistor 618a. The power supply line connected at the contact “a” is connected to an A/D port of the CPU 601. With such a configuration, the CPU 601 can detect the conductive state or the cutoff state (open state) of the transistor 617a.

Now, the operation of the voltage detection unit 611a is described. The voltage detection unit 611a detects each of rising and falling of the power supply voltage applied from the main board 600 with, for example, a threshold value of 4 V. However, the voltage detection unit 611a does not detect the rising when the voltage changes from 0 V to at least 4 V at power-on. The voltage detection unit 611a is in a “first state” in an initial state at power-on, and maintains the first state until the falling of the applied power supply voltage across 4 V is detected after the applied power supply voltage temporarily becomes equal to or higher than 4 V (for example, 5 V). When the falling of the applied power supply voltage across 4 V is detected, the voltage detection unit 611a is brought into a “second state”. After that, when the rising of the applied power supply voltage across 4 V is detected again, the voltage detection unit 611a is brought into a “third state”. The voltage detection unit 611a that has been brought into the third state maintains the third state until the power supply voltage changes to 0 V. The changing of the power supply voltage to 0 V is referred to as “initialization”. The voltage detection unit 611a returns to the first state by being initialized.

While being in the initial state (first state) at power-on, the voltage detection unit 611a controls the power cutoff unit 612a to be in a cutoff state in which the power supply voltage is not supplied to the second sensor 502 on the downstream side. While being in the second state, the voltage detection unit 611a also controls the power cutoff unit 612a to be in the cutoff state. While being in the third state, the voltage detection unit 611a controls the power cutoff unit 612a to be in a conductive state in which the power supply voltage is supplied to the second sensor 502 on the downstream side.

That is, when the voltage detection unit 611a is in the initial state (first state) at power-on, the power cutoff unit 612a is in the cutoff state in which the power supply voltage is not supplied to the second sensor 502 on the downstream side. When the voltage detection unit 611a is in the second state, the power cutoff unit 612a also maintains the cutoff state. When the voltage detection unit 611a is in the third state, the power cutoff unit 612a is brought into the conductive state in which the power supply voltage is supplied to the second sensor 502 on the downstream side.

While being in the first state, the voltage detection unit 611a controls the LED controller 615a to be in a conductive state in which a current is supplied to the LED 613a to cause the LED 613a to emit light. While being in the the second state, the voltage detection unit 611a controls the LED controller 615a to be in a cutoff state in which the current supplied to the LED 613a is cut off to cause the LED 613a to turn out the light. When being brought into the third state after that, the voltage detection unit 611a maintains the LED controller 615a in the cutoff state. While being in the third state, the voltage detection unit 611a maintains the LED controller 615a in the cutoff state until the power supply voltage reaches 0 V (is initialized).

That is, when the voltage detection unit 611a is in the first state, the LED controller 615a is in the conductive state, and supplies a current to the LED 613a to cause the LED 613a to emit light. When the voltage detection unit 611a is brought into the second state, the LED controller 615a is brought into the cutoff state, and cuts off the current supplied to the LED 613a to cause the LED 613a to turn out the light. When the voltage detection unit 611a is brought into the third state after that, the LED controller 615a maintains the cutoff state until the power supply voltage is changed to 0 V (is initialized).

When the voltage detection unit 611a is in the first state, the transistor 617a of the sensor latch unit 616a is in a cutoff state. When the voltage detection unit 611a is switched from the first state to the second state, the sensor latch unit 616a latches a state signal (detection result) obtained from the phototransistor 614a, and operates the transistor 617a based on the latched result.

In a case where the phototransistor 614a is in the conductive state (with an input of 0 V) when the voltage detection unit 611a is switched from the first state to the second state, the sensor latch unit 616a maintains the transistor 617a in a conductive state. When the phototransistor 614a is in the cutoff state (with an input at a power supply voltage level), the sensor latch unit 616a maintains the transistor 617a in a cutoff state. At this timing, the CPU 601 acquires a voltage value at the contact “a” in the power supply line, which is determined based on the state of the transistor 617a, to thereby be able to acquire the detection result of the first sensor 501.

When the voltage detection unit 611a is switched to the third state after that, the sensor latch unit 616a brings the transistor 617a into the cutoff state. The sensor latch unit 616a maintains this state until the power supply voltage is changed to 0 V (initialized). In this manner, the sensor latch unit 616a maintains a light receiving state of the phototransistor 614a.

A connector 610b of the second sensor 502 is not only connected to the first sensor 501 on the upstream side through the power supply line, but also connected to the third sensor 503 provided on the downstream side through another power supply line. The second sensor 502 includes a voltage detection unit 611b, a power cutoff unit 612b, an LED 613b, a phototransistor 614b, an LED controller 615b, and a sensor latch unit 616b. Operations of the respective components are the same as the operations of the respective corresponding components of the first sensor 501, and hence descriptions thereof are omitted.

A collector terminal of a transistor 617b in the sensor latch unit 616b is connected to the power supply line of the second sensor 502 at a contact “b” via a resistor 618b. The contact “b” is connected to the A/D port of the CPU 601 of the main board 600 via the first sensor 501. With such a configuration, the CPU 601 can detect a conductive state or a cutoff state of the transistor 617b.

A connector 610c of the third sensor 503 is connected to the second sensor 502 on the upstream side through the power supply line. The third sensor 503 is arranged on the most downstream side of series connection, and hence the connector 610c is not connected to any component in the subsequent stage. The third sensor 503 includes a voltage detection unit 611c, a power cutoff unit 612c, an LED 613c, a phototransistor 614c, an LED controller 615c, and a sensor latch unit 616c. Operations of the respective components are the same as the operations of the respective corresponding components of the first sensor 501, and hence descriptions thereof are omitted.

A collector terminal of the transistor 617c in the sensor latch unit 616c is connected to the power supply line of the third sensor 503 at a contact “c” via a resistor 618c. The contact “c” is connected to the A/D port of the CPU 601 of the main board 600 via the first sensor 501 and the second sensor 502. With such a configuration, the CPU 601 can detect a conductive state or a cutoff state of the transistor 617c.

With the above-mentioned configuration, the first sensor 501 to the third sensor 503 perform the same operation in response to an input signal (power supply voltage). However, by shifting a timing to supply power to the respective sensors, the CPU 601 can independently detect the states of all the sensors. That is, the main board 600 alternately applies two kinds of power supply voltages (5 V and 3.3 V) to a plurality of sensors, to thereby cause the respective sensors to sequentially perform the detection operations. For example, the main board 600 applies the power supply voltage while sequentially switching the respective voltage values irrespective of the conveyance timing of the sheet 110.

The main board 600 resets the states of the respective sensors by applying another power supply voltage (0 V), and causes the sensors to again perform the detection operations sequentially from the first stage. Each sensor can use the same interface for connection to the main board 600 or another sensor irrespective of a connection point (most upstream, most downstream, or halfway) in the series connection. Therefore, the same interface can be used for all the sensors. In this embodiment, the number of sensors connected in series is three, but it is also possible to further increase the number of sensors under the same control.

The plurality of sensors can be connected in this manner, to thereby suppress the number of power supply lines for connecting the main board 600 and the plurality of sensors (first sensor 501 to third sensor 503). In addition, the power supply line is used both for supplying the power supply voltage and for acquiring the detection result, and hence series wires for connecting the main board 600 and the respective sensors (first sensor 501 to third sensor 503) can be reduced to two lines including a ground line. In short, a plurality of sensors of the same kind (having the same outer shape and the same internal circuit) are connected in series. The respective sensors can independently perform the detection operations. Therefore, it is possible to reduce the number of cables and the number of connectors, and suppress costs including a component management cost.

### Normal Operation Mode

The image forming apparatus 100 according to this embodiment operates in any one of operation modes of a normal operation mode in a printing standby state and a power reduction mode in which overall power consumption is suppressed. In the normal operation mode, power is supplied to each component of the image forming apparatus 100. In the power reduction mode, power is supplied to some components of the image forming apparatus 100.

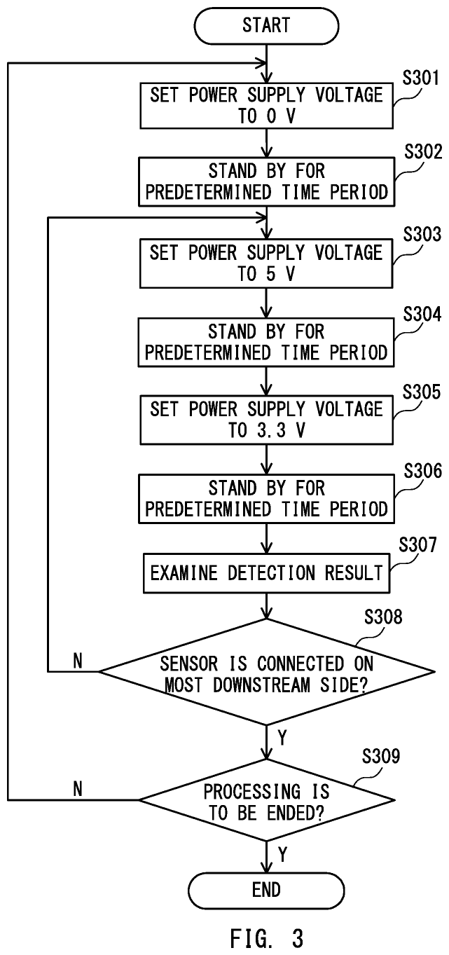

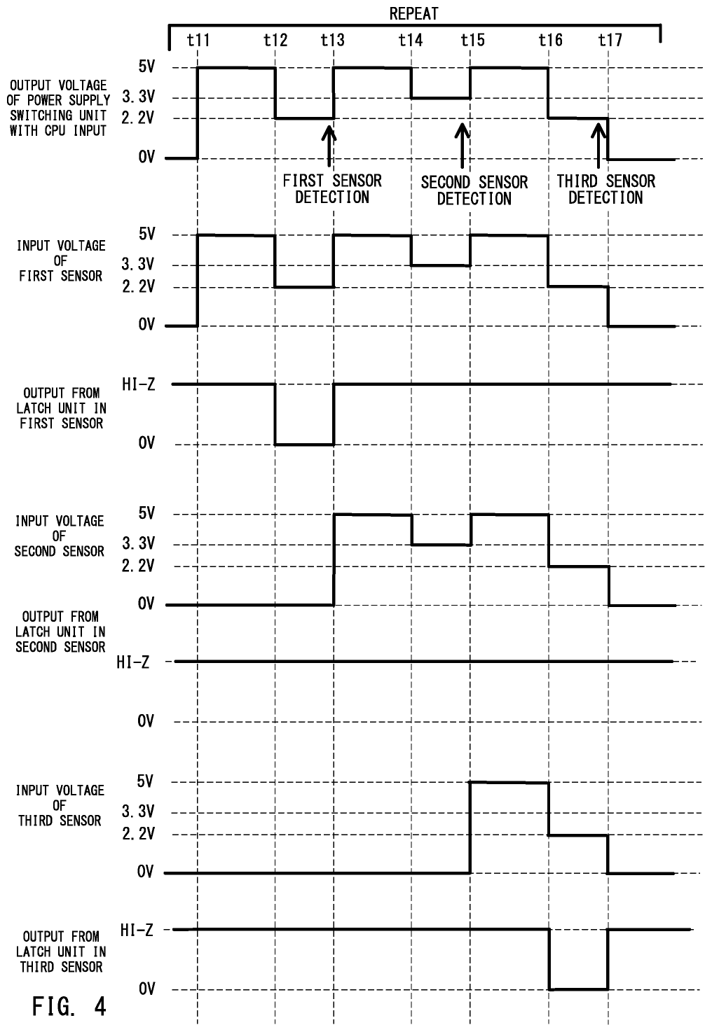

FIG. 3 is a flow chart for illustrating operation control processing for a sensor, which is performed by the main board 600 at a time of the normal operation mode. FIG. 4 is a timing chart exhibited when the operations of the respective sensors are controlled at the time of the normal operation mode. In the normal operation mode, all of the first sensor 501 to the third sensor 503 operate.

When the sensor has started a detection operation, the CPU 601 first sets the power supply voltage output by the power supply switching unit 602 to 0 V (Step S301). The CPU 601 stands by for a predetermined time period (in this embodiment, 100 microseconds) while maintaining the power supply voltage at 0 V (Step S302). The predetermined time period is set as a time period long enough to control the power cutoff units 612a, 612b, and 612c to a cutoff state (state in which the power supply voltage is not supplied to the second sensor 502 and the third sensor 503) being an initial state.

When the predetermined time period has elapsed since the power supply voltage was set to 0 V, the CPU 601 sets the power supply voltage output by the power supply switching unit 602 to 5 V (Step S303). At this time, the voltage detection unit 611a is in the first state, and the LED controller 615a causes the LED 613a to emit light. The power cutoff unit 612a is in the cutoff state, and hence the power supply voltage is not supplied to the second sensor 502 and the third sensor 503. The CPU 601 stands by for a predetermined time period (in this embodiment, 100 microseconds) while maintaining the power supply voltage at 5 V (Step S304). The predetermined time period is a time period during which the LED 613a emits light and the light receiving operation is reliably performed by the phototransistor 614a.

After a lapse of the predetermined time period, the CPU 601 causes the power supply switching unit 602 to set the power supply voltage to 3.3 V pulled up by the pull-up resistor 606 (Step S305). With this setting, the voltage detection unit 611a detects the falling of the power supply voltage to be brought into the second state. When the voltage detection unit 611a is brought into the second state, the sensor latch unit 616a latches the state (detection result) of the phototransistor 614a to switch the operation state of the transistor 617a. The sensor latch unit 616a maintains the transistor 617a in the conductive state when the phototransistor 614a is in the conductive state, and maintains the transistor 617a in the cutoff state when the phototransistor 614a is in the cutoff state.

When the voltage detection unit 611a is brought into the second state, the LED controller 615a is brought into the cutoff state, and the LED 613a turns out the light. The LED 613a turns out the light, and hence the phototransistor 614a is brought into the cutoff state. At this time, when the LED 613a completes an operation for turning out the light early with respect to a latching operation performed by the sensor latch unit 616a, there is a fear that the state of the phototransistor 614a exhibited when the LED 613a emits light, which is originally to be acquired, may not be latched. Therefore, the voltage detection unit 611a delays the transmission of the control signal to the LED controller 615a as compared to the transmission of the switching signal to the sensor latch unit 616a. The processing from Step S303 to Step S305 is processing performed between a time t11 and a time t12 in FIG. 4.

The CPU 601 stands by for a predetermined time period (in this embodiment, 75 microseconds) while maintaining the power supply voltage at 3.3 V (Step S306). The predetermined time period is a time period longer than a time period for switching the states of the voltage detection unit 611a and the sensor latch unit 616a.

When the predetermined time period has elapsed with the power supply voltage being maintained at 3.3 V, the CPU 601 acquires the voltage value of the power supply line to which the contact “a” in the first sensor 501 is connected to examine the detection result of the first sensor 501 (Step S307). With the above-mentioned processing, the CPU 601 detects whether or not the transistor 617a is in an operation state or a non-operation state (open). The processing of Step S306 and Step S307 is processing performed between the time t12 and a time t13 in FIG. 4.

The power supply line for connecting the contact “a” in the first sensor 501 and the CPU 601 is also connected to the power supply line from the second sensor 502 and the third sensor 503. However, the power cutoff unit 612a of the first sensor 501 is in the cutoff state, and hence the power supply voltage is not supplied to the second sensor 502 and the third sensor 503. The voltage detection unit 611a and the LED controller 615a are also connected to the contact “a” in the first sensor 501, but a current consumed by voltage detection and light emission control of the LED 613a is small with no current flowing through the LED 613a, and thus current consumption is minute. For this reason, at the time of the processing of Step S307, the voltage value of the power supply line is dominated by the transistor 617a in operation. Therefore, the voltage value at the contact “a” (power supply line) connected to the A/D port of the CPU 601 is substantially determined based on the conductive state and the cutoff state of the transistor 617a.

When the transistor 617a is in the conductive state, the voltage value to be acquired by the CPU 601 is determined based on a voltage dividing ratio between the pull-up resistor 606 and the resistor 618a. In this embodiment, assuming that the pull-up resistor 606 has a resistance value of 1.1 kΩ and the resistor 618a has a resistance value of 2.2 kΩ, the CPU 601 detects about 2.2 V (first sensor detection in FIG. 4). When the transistor 617a is in the cutoff state, no current flows through the transistor 617a as well, and almost no current flows through the power supply line. Therefore, the CPU 601 detects about 3.3 V.

The CPU 601 compares an A/D conversion result of the voltage value acquired at the A/D port with a predetermined threshold value to determine whether or not the transistor 617a is in the conductive state. In this embodiment, the threshold value is set to 2.75 V. When the A/D conversion result is lower than 2.75 V, the CPU 601 determines that the transistor 617a is in the conductive state, and that the first sensor 501 has not detected the sheet 110. When the A/D conversion result is equal to or higher than 2.75 V, the CPU 601 determines that the transistor 617a is in the cutoff state, and that the first sensor 501 has detected the sheet 110.

The CPU 601, which has acquired the detection result of the sensor, determines whether or not the sensor is connected on the most downstream side of the series connection (Step S308). For example, the configuration (including the number) of sensors connected in series is registered in the CPU 601 in advance, and the CPU 601 determines based on the registered configuration and the number of the acquired detection results whether or not the sensor from which the detection result has been acquired is connected on the most downstream side. In this case, the CPU 601 has acquired the detection result of the first sensor 501. Therefore, the CPU 601 determines that the sensor from which the detection result has been acquired is not connected on the most downstream side (N in Step S308), and repeatedly performs the processing of Step S303 and the subsequent steps.

When the sensor from which the detection result has been acquired is not connected on the most downstream side, the CPU 601 sets the power supply voltage output by the power supply switching unit 602 to 5 V (Step S303). At this time, the voltage detection unit 611a of the first sensor 501 is changed to the third state. For that reason, the sensor latch unit 616a brings the transistor 617a into the cutoff state. The power cutoff unit 612a is brought into the conductive state, and the power supply voltage is supplied to the second sensor 502 on the downstream side.

In the same manner as in the case of the first sensor 501, the CPU 601 acquires the detection result of the second sensor 502 (Step S304, Step S305, Step S306, and Step S307). In the processing of Step S307, the transistor 617a of the first sensor 501 is in the cutoff state, and the third sensor 503 is not operating. Therefore, the input signal supplied to the A/D port of the CPU 601 changes based on only the state of the transistor 617b of the second sensor 502. The processing from Step S303 to Step S307 is processing performed between the time t13 and a time t15 in FIG. 4. In FIG. 4, a state in which a shielding object is provided between the LED 613b and the phototransistor 614b of the second sensor 502 is illustrated as an example. In this case, the phototransistor 614b does not receive light, and is brought into the cutoff state (high impedance). The voltage value acquired by the CPU 601 at the A/D port is 3.3 V.

The second sensor 502 is not connected on the most downstream side of the series connection (N in Step S308), and hence the CPU 601, which has acquired the detection result of the second sensor 502, again repeats the processing of Step S303 and the subsequent steps. When the processing of Step S303 and the subsequent steps are repeated again, the CPU 601 sets the power supply voltage output by the power supply switching unit 602 to 5 V (Step S303). At this time, the voltage detection unit 611b of the second sensor 502 is changed to the third state. Therefore, the sensor latch unit 616b brings the transistor 617b into the cutoff state. The power cutoff unit 612b is brought into the conductive state, and the power supply voltage is supplied to the third sensor 503 on the downstream side.

In the same manner as in the cases of the first sensor 501 and the second sensor 502, the CPU 601 acquires the detection result of the third sensor 503 (Step S304, Step S305, Step S306, and Step S307). In the processing of Step S307, the transistor 617a of the first sensor 501 and the transistor 617b of the second sensor 502 are in the cutoff state. Therefore, the input signal supplied to the A/D port of the CPU 601 changes based on only the state of the transistor 617c of the third sensor 503. The processing from Step S303 to Step S307 is processing performed between the time t15 and a time t17 in FIG. 4. In FIG. 4, a shielding object is not provided between the LED 613c and the phototransistor 614c of the third sensor 503, and the phototransistor 614c receives light to be brought into a conductive state. In this case, the voltage value acquired by the CPU 601 at the A/D port is 2.2 V.

The CPU 601, which has acquired the detection result of the third sensor 503, determines whether or not the third sensor 503 is connected on the most downstream side of the series connection (Step S308). The CPU 601 has acquired the detection result of the third sensor 503, and hence determines that the sensor from which the detection result has been acquired is connected on the most downstream side (Y in Step S308).

The CPU 601, which have acquired the detection results from all of the first sensor 501 to the third sensor 503, determines whether or not to bring the detection operation to an end. When the detection operation is to be brought to an end (Y in Step S309), the CPU 601 brings the processing to an end.

To continue the detection operation (N in Step S309), the CPU 601 returns to the processing of Step S301 to set the power supply voltage output by the power supply switching unit 602 to 0 V, and stands by for a predetermined time period. With this processing, the respective states of the voltage detection units 611a, 611b, and 611c of the first sensor 501 to the third sensor 503, which are connected in series, are initialized to be brought into the first state. The power cutoff units 612a, 612b, and 612c are brought into the cutoff state being the initial state, to thereby cut off the power supply voltage supplied to the sensor on the downstream side. After that, the CPU 601 repeatedly performs the processing from Step S303 to Step S309, to thereby be able to detect the states of the first sensor 501 to the third sensor 503 at all times. In this manner, in the normal operation mode, the first sensor 501 to the third sensor 503 perform the detection operation in order.

### Power Reduction Mode

The power reduction mode is an operation mode in which power is supplied only to minimum required components of the image forming apparatus 100 when, for example, an operation or a print job is not input to the image forming apparatus 100 for at least a predetermined time period at the time of the normal operation mode. The image forming apparatus 100 detects that, for example, the sheet 110 has been placed on the manual feed tray 120, to thereby change the operation mode from the power reduction mode to the normal operation mode. In this embodiment, the placement of the sheet 110 on the manual feed tray 120 is detected by the first sensor 501.

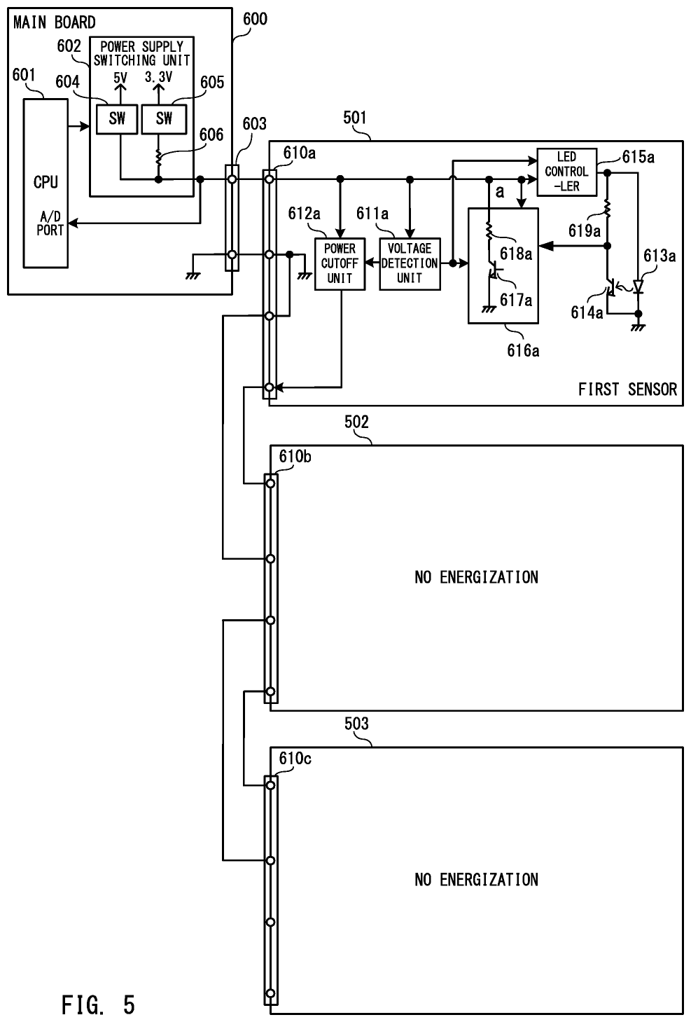

FIG. 5 is an explanatory diagram of power supply states of the main board 600 and the first sensor 501 to the third sensor 503 at a time of the power reduction mode. At the time of the power reduction mode, the normal operation mode is changed to the operation mode when the first sensor 501 detects the sheet 110, and hence it suffices that only the first sensor 501 is operable. As described above, the plurality of sensors connected in series operate by being supplied with power via the sensor on the upstream side. It is preferred that the minimum number of sensors be operable in the power reduction mode. To that end, the sensor required to be operated at the time of the power reduction mode is arranged on the most upstream side of the series connection.

In this embodiment, the first sensor 501 is arranged on the most upstream side of the plurality of sensors connected in series, and operates. The second sensor 502 and the third sensor 503 arranged on downstream of the first sensor 501 are not energized at the time of the power reduction mode, and hence power is not supplied thereto. In short, the power cutoff unit 612a of the first sensor 501 is maintained in the cutoff state in the power reduction mode at all times. Supposing that the first sensor 501 is connected on the downstream side of the second sensor 502, power cannot be supplied to the first sensor 501 unless the second sensor 502 is energized. In this embodiment, the first sensor 501 is arranged on the most upstream side, to thereby be able to suppress wasteful power consumption in the power reduction mode.

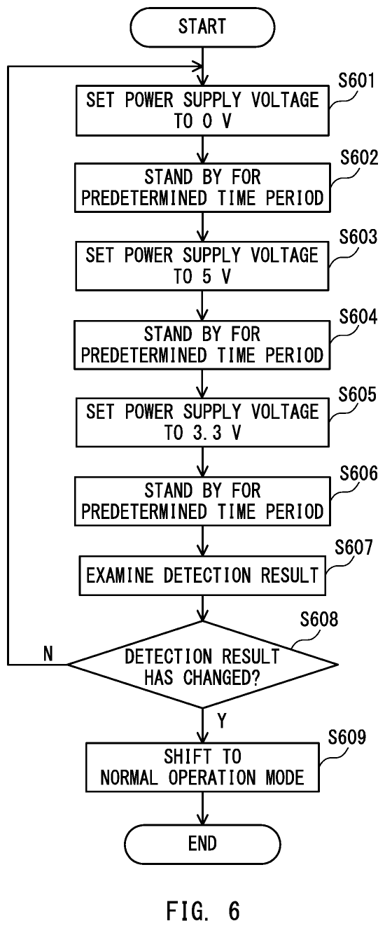

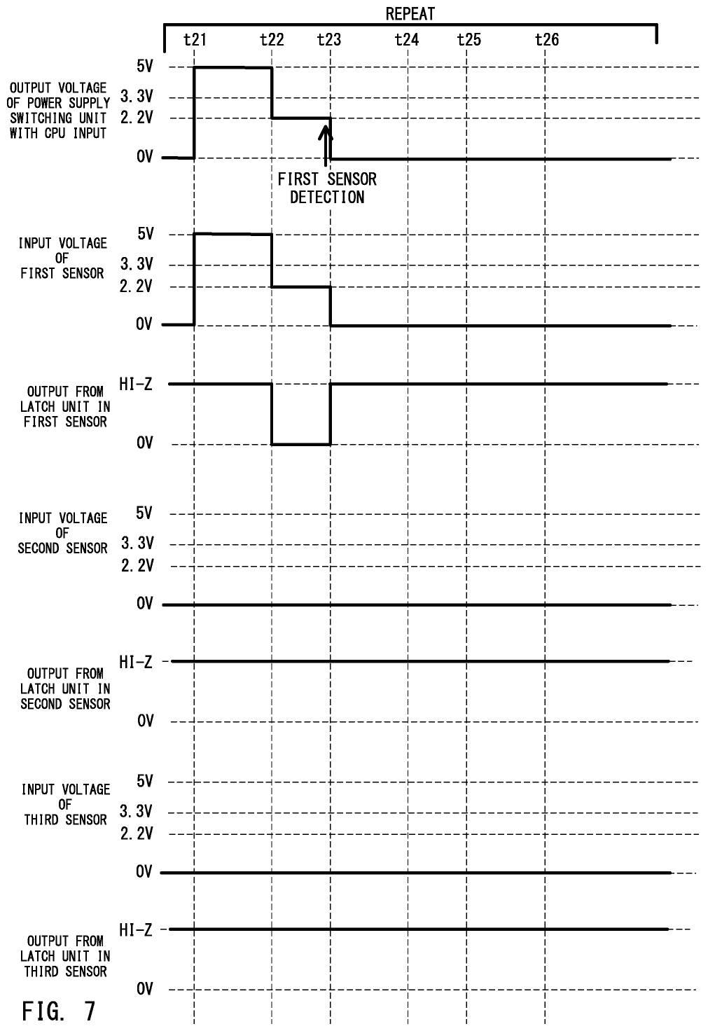

FIG. 6 is a flow chart for illustrating operation control processing for a sensor which is performed by the main board 600 at the time of the power reduction mode. FIG. 7 is a timing chart exhibited when the operations of the respective sensors are controlled at the time of the power reduction mode. In the power reduction mode, the operation of a part (first sensor 501) of the first sensor 501 to the third sensor 503 is controlled.

At the time of the power reduction mode, the CPU 601 acquires the detection result of the first sensor 501 by the same processing as the processing from Step S301 to Step S307 in FIG. 3 (Step S601 to Step S607). The processing from Step S601 to Step S607 is processing performed between a time t21 and a time t23 in FIG. 7. The CPU 601 determines whether or not the acquired detection result of the first sensor 501 has changed from the previous detection result (Step S608). The CPU 601 stores, for example, the detection result of the first sensor 501 in a memory (not shown) provided on the main board 600. The CPU 601 compares the acquired detection result with the previous detection result stored in the memory, to thereby determine whether or not the detection result of the first sensor 501 has changed. The processing of Step S608 is performed between the time t23 and a time t26 in FIG. 7.

When the detection result has not changed (N in Step S608), the CPU 601 repeatedly performs the processing of Step S601 and the subsequent steps. The CPU 601 sets the power supply voltage to 0 V by the processing of Step S601, and stands by for a predetermined time period. With the processing, the respective states of the voltage detection units 611a, 611b, and 611c of the first sensor 501 to the third sensor 503, which are connected in series, are initialized to be brought into the first state. The power cutoff units 612a, 612b, and 612c are brought into the cutoff state being the initial state, to thereby cut off the power supply voltage supplied to the sensor on the downstream side. That is, the CPU 601 acquires the detection result of the first sensor 501, and when there is no change from the previous detection result, initializes the first sensor 501 to the third sensor 503. Therefore, when the processing from Step S601 to Step S608 is repeatedly performed, only the first sensor 501 is energized and operates, and the second sensor 502 and the third sensor 503 are not energized and do not operate.

When the detection result has changed (Y in Step S608), the CPU 601 advances to the processing for the normal operation mode in FIG. 3 (Step S609) while bringing the power reduction mode to an end. In this case, the change of the detection result of the first sensor 501 means the placement of the sheet 110 on the manual feed tray 120. The CPU 601 detects the placement of the sheet 110 based on the change of the detection result of the first sensor 501, and shifts to the normal operation mode to be brought into a state that enables image forming processing.

The CPU 601 not only determines the placement of the sheet 110 on the manual feed tray 120 based on the change of the detection result, but also may detect that the sheet 110 has been placed on the manual feed tray 120 based on the value of the detection result. For example, the CPU 601 detects that the sheet 110 has been placed on the manual feed tray 120 when the detection result is 2.2 V, which is lower than a predetermined threshold value. The CPU 601 detects that the sheet 110 has not been placed on the manual feed tray 120 when the detection result is 3.3 V, which is higher than a predetermined threshold value.

As described above, the image forming apparatus 100 according to this embodiment energizes only a part (in this case, first sensor 501) of the sensors so as to become operable in order to obtain information required for shifting to the normal operation mode at the time of the power reduction mode of saving power. The other sensors are not required to operate, and are not therefore energized. This allows the image forming apparatus 100 to suppress unnecessary power consumption. In this manner, the present disclosure can suppress power consumption by arranging, on the upstream side, the sensor required to be operated at the time of the power reduction mode.

There may be at least two sensors (for example, first sensor 501 and second sensor 502) required to be operated in the power reduction mode. In this case, after acquiring the detection result of the sensor on the most downstream side among the sensors required to be operated, the CPU 601 sets the power supply voltage to 0 V to reset all the sensors. For example, when the detection result has not changed after the processing from Step S601 to Step S608 in FIG. 6 was performed, the CPU 601 performs the processing of Step S308 in FIG. 3. When it is determined in the processing of Step S308 that the sensor from which the detection result has been acquired is not the sensor on the most downstream side among the sensors required to be operated, the CPU 601 performs the processing from Step S603 to Step S608 in FIG. 6. When it is determined in the processing of Step S308 that the sensor from which the detection result has been acquired is the sensor on the most downstream side among the sensors required to be operated, the CPU 601 again performs the processing of Step S601 and the subsequent steps.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-104003, filed May 30, 2018 which is hereby incorporated by reference herein in its entirety.

What is claimed is:

1. A sensor assembly, comprising:
a plurality of sensors electrically connected in series; and
a controller configured to control each of the plurality of sensors in sequence,
wherein the plurality of sensors includes a first sensor and a second sensor,
wherein the second sensor is electrically connected to the controller through the first sensor,
wherein the controller performs a first operation mode in which the first sensor and the second sensor are repeatedly operated, and a second operation mode in which the first sensor is repeatedly operated by skipping the second sensor.

2. The sensor assembly according to claim 1, further comprising a power supply unit configured to supply power to the plurality of sensors,
wherein the plurality of sensors are each configured to become operable by being supplied with power from the power supply unit, and
wherein the controller is configured to:
cause, in the first operation mode, the power supply unit to sequentially supply power to the plurality of sensors; and
cause, in the second operation mode, the power supply unit to supply power to the first sensor without causing the power supply unit to supply power to the second sensor.

3. The sensor assembly according to claim 1,
wherein the plurality of sensors further includes a third sensor connected to the controller,
wherein the controller is configured to:
operate the plurality of sensors in order from the third sensor in the first operation mode; and
operate the third sensor and the first sensor in order from the third sensor in the second operation mode.

4. The sensor assembly according to claim 1,
wherein the plurality of sensors each include:
a detector configured to perform a detection operation;
a power line configured to supply a voltage applied by the controller to one of the plurality of sensors connected to a subsequent stage;
a switch unit provided in the power line; and
a conduction controller configured to:
operate the detector and cut off the switch unit when the applied voltage is a first voltage;
stop the detector and cut off the switch unit when the applied voltage is a second voltage different from the first voltage;
cause, when the applied voltage has changed from the second voltage to the first voltage, the switch unit to become conductive while stopping the detector; and
operate the detector and cut off the switch unit when the applied voltage is a third voltage different from the first voltage and the second voltage, and
wherein the controller is configured to apply, at a time of the second operation mode, voltages in order of the first voltage, the second voltage, and the first voltage to the first sensors except one of the first sensors, which is connected on a subsequent stage thereof to the second sensor, in order from one of the first sensors that is arranged on a most upstream side, apply voltages in order of the first voltage and the second voltage to the one of the first sensors, which is connected on the subsequent stage thereof to the second sensor, and then apply the third voltage to all the first sensors.

5. The sensor assembly according to claim 4, wherein the controller is configured to apply the first voltage and then apply the second voltage to any one of the plurality of sensors, to thereby acquire a detection result from the any one of the plurality of sensors.

6. The sensor assembly according to claim 5, wherein the controller is configured to shift an operation mode to the first operation mode when the detection result acquired from the any one of the first sensors has changed at the time of the second operation mode.

7. The sensor assembly according to claim 4, wherein the controller is configured to apply, at a time of the first operation mode, voltages in order of the first voltage, the second voltage, and the first voltage to the plurality of sensors except one of the plurality of sensors that is arranged on a most downstream side in order from one of the plurality of sensors that is arranged on the most upstream side, apply voltages in order of the first voltage, the second voltage, and the first voltage to the one of the plurality of sensors that is arranged on the most downstream side, and then apply the third voltage to all the plurality of sensors.

8. The sensor assembly according to claim 4,
wherein the controller and one of the plurality of sensors that is arranged on the most upstream side are connected to each other by a single power supply line,
wherein the respective plurality of sensors are connected in series by mutually different single power supply lines, and
wherein the respective power supply lines are connectable via the switch unit.

9. The sensor assembly according to claim 8, wherein the controller is configured to apply the voltage to the plurality of sensors through the respective power supply lines to acquire detection results from the plurality of sensors through the respective power supply lines.

10. An image forming apparatus, comprising:
a placement portion on which a sheet is to be placed;
an image forming unit configured to form an image on the sheet;
a conveyor configured to convey the sheet from the placement portion to the image forming unit through a conveyance path;
a controller; and
a plurality of sensors electrically connected in series to the controller,
wherein the controller is configured to operate the plurality of sensors based on a first operation mode of operating all the plurality of sensors and a second operation mode of operating a part of the plurality of sensors,
wherein the plurality of sensors include a first sensor configured to operate in the second operation mode and a second sensor configured to avoid operating in the second operation mode so that the first sensor is arranged on an upstream side of the second sensor, the upstream side being set to a side on which the controller is provided, and
wherein the plurality of sensors are arranged on the conveyance path at predetermined intervals, and are each configured to detect the sheet.

11. The image forming apparatus according to claim 10 wherein the controller is configured to apply a first voltage, a second voltage, and a third voltage to the plurality of sensors irrespective of a conveyance timing of the sheet.
